(19) United States
(12) Patent Application Publication
(10) Pub. No.: US 2003/0005750 A1
(43) Pub. Date: Jan. 9, 2003

(54) Characterization of membranes

(76) Inventors: Harry William Deckman, Clinton, NJ (US); Ronald Richard Chance, Annandale, NJ (US); Don M. Cox, Watchung, NJ (US); Wim Guy De Gijnst, Nieuwerkerken (BE); James Alexander. McHenry, Washington, NJ (US); Juan Jose Reinoso, Houston, TX (US)

Correspondence Address: ExxonMobil Chemical Company, P.O. Box 2149, Baytown, TX, 77522, US

(21) Appl. No.: 10/051,414

(22) Filed: Jan. 18, 2002

(30) Foreign Application Priority Data
Jan. 19, 2001 (GB) 0101406.7

(51) Int. Cl. G01N 15/08

(52) U.S. Cl. 73/38

(57) ABSTRACT

Methods are described for the characterization of microporous membranes such as crystalline molecular sieve membranes. The methods are based on the exposure of a membrane to a non-condensable inert gas e.g. helium, which may be transported through selective and non-selective pathways within the membrane, while at the same time exposing the membrane to increasing partial pressures of a condensable material in the form of a vapor or a gas. The condensable material may also be transported through the selective and non-selective pathways in the membrane. The condensable material progressively fills the pathways of the membrane and progressively attenuates the permeance of the non-condensable inert gas allowing detection and determination of non-selective pathways in the membrane.

### BACKGROUND OF THE INVENTION

This invention relates to membranes and their characterization and in particular to the characterization of microporous membranes and especially microporous membranes such as molecular sieve membranes.

Membranes are becoming increasingly important in many fields of application and have many uses in physical, physicochemical, and chemical processes. Inorganic membranes and in particular microporous membranes such as for example molecular sieve membranes may also be used as selective sorbents, effecting separation of components in mixtures, and as catalysts.

A critical issue with any membrane is the quality of the membrane. One important quality parameter is the detection and measurement of selective transport and non-selective transport paths. The exact nature of the selective and non-selective transport paths depends on the material that constitutes the membrane. Microporous membranes may be amorphous, crystalline, or polycrystalline with crystalline pores as is typical with zeolite membranes. For example, in the case of crystalline molecular sieve membranes selective transport paths are intracrystalline transport paths and non-selective transport paths are intercrystalline, cracks, and/or point defects. Amorphous microporous membranes may also exhibit point defects cracks, or non-selective pathways. Conventionally, with polycrystalline molecular sieve membranes, intercrystalline paths, cracks or defects in inorganic membranes have been detected and observed by means of microscopy techniques such as optical and/or electron microscopy techniques. Relatively large surface cracks and point defects which break the surface of the layer may easily be detected with these techniques. The detection and quantification of intercrystalline transport paths would normally require that a section of the layer be taken to detect and observe the defect. This would effectively require destruction of the finished membrane layer for characterization purposes and clearly could not be effectively used in quality control where destruction is to be avoided. Cracks, visible on the surface of the membrane, would normally indicate that a non-selective transport paths are present in the membrane. However, in some instances the molecular sieve membrane may exhibit a significant degree of surface cracked topography while at the same time being highly selective for various separations; clearly there are less non-selective transport paths than expected in such circumstances.

Measurement of single component gas permeation as a function of temperature and pressure allows a relatively quick, but often qualitative identification of the separation e.g. molecular sieving and surface diffusion properties of membranes. The quantitative interpretation of single component gas permeation measurements is extremely complex when there are parallel non-selective as well as selective diffusion pathways through the layer which controls the mass transfer resistance. Molecular sieve membranes such as zeolite membranes often contain crack structures, crystalline grain boundaries, point defects, and complex internal structures; all of which can act as non-selective transport paths. As such, the interpretation of transport through such membranes can be very complex.

An important aspect in the manufacture and use of any membrane is, as far as possible, to be able to satisfactorily characterize the membrane and to quality control the membrane or membrane module during its production. It is also desirable to be able to periodically monitor the status of a membrane in-situ during its application lifetime. In this instance a simple and rapid method for determining that the membrane in-situ has not developed cracks i.e. non-selective pathways, during use, would be beneficial. Furthermore an accurate and reproducible method of qualitatively and/or quantitatively determining the non-selective transport paths may enable suitable reparation techniques to be used.

There are a number of techniques known in the art for the characterization of membranes. However, while many of these techniques are suitable for characterising membranes which have pose sizes within the mesoporous range (pore diameters of 2 to 50 nm) or in the macroporous range (pore diameters of>50 nm), it has previously been difficult to effectively characterize membranes which have pore sizes within the microporous range (less than 2 nm and typically within the range of 0.25 to 2 nm).

It is clear therefore that conventional techniques such as microscopy or single component gas diffusion properties are not completely satisfactory for the characterization of membranes and/or for use in quality control during production of such membranes and in particular microporous membranes. There is therefore a need for a simple, reproducible and accurate method for characterising membranes especially microporous membranes such as for example molecular sieve membranes and in particular, a method that may be used to detect the presence of and quantitatively identify non-selective transport paths.

### SUMMARY OF THE INVENTION

The present invention is concerned with testing methods which can qualitatively and/or quantitatively identify the flow along selective and non-selective transport paths in microporous membranes e.g. molecular sieve membranes. These methods involve simple physical measurements that are easy to implement and can be rapidly carried out without destruction of the finished membrane or membrane module. These methods lend themselves to the effective quality control of microporous membranes.

The methods of the present invention allow the rapid quantitative measurement of the transport through the pores of microporous membranes such as zeolite membranes, as well as quantification of the bypass (defect) or non-zeolitic flow.

### DESCRIPTION OF THE PREFERRED EMBODIMENTS

In one aspect of the present the method of the present invention is based on the exposure of a microporous membrane to a non-condensable inert gas such as for example helium, which may be transported through the selective and non-selective pathways in the membrane, while at the same time exposing the membrane to increasing partial pressures of a condensable material in the form of a vapor or a gas. The condensable material may also be transported through the selective and non-selective pathways in the membrane.

The condensable gas should have a molecular size such that it may easily penetrate the micropores of the membrane; it should also be strongly adsorbed in the micropores. For example, normal hexane is suitable for molecular sieve membranes such as MFI type zeolite, zeolite X and zeolite Y. Those skilled in the art will be able to select suitable condensable materials for use with other types of microporous membranes.

The temperature at which the characterization method of the present invention is conducted should be in a suitable range for the condensable gas to strongly adsorb to the material of the microporous membrane. This can be deduced by those skilled in the art via the use of suitable adsorption isotherms. When normal hexane is used to characterize MFI type molecular sieve membranes, the temperature should be below 175° C., preferably below 100° C., most preferably at room temperature.

During exposure the selective and non-selective pathways of the membrane are progressively filled with the condensable material as the partial pressure of this material increases. As a pathway is filled with condensable material, the non-condensable gas is no longer able to pass through and the overall permeance of the non-condensable gas through the membrane is attenuated. As successively larger pathways e.g. non-selective pathways are filled with condensable material the permeance of the non-condensable gas is further attenuated.

The method therefore involves measuring the flow of a non-condensable inert gas such as for example helium through a membrane as the pores of a membrane are progressively filled by increasing the partial pressure of a condensable gas e.g. hexane carried in the non-condensable gas e.g. helium.

The key aspect of this method is that at extremely low activities of the condensable gas the pores of the microporous membrane will be filled with condensed material and block the helium flow. If the membrane is defect free, all helium flow will be blocked at very low activity. Thus it is possible with this method to identify membranes which are defect free i.e. do not contain significant non-selective pathways. However, this will often not be the case as many microporous membranes, depending on their method of manufacture, will have some larger non-selective pathways (intercrystalline, cracks, point defects) through which the non-condensable gas can continue to flow. At increasing activity capillary condensation will progressively reduce the flow of the non-condensable gas as the smaller to larger pores along the non-selective pathways become blocked with condensed material. This method thus allows one to examine the separation properties e.g. molecular sieving properties, of the membrane and also to obtain information as to the defect pore size and abundance of such defects in the membrane layer. In addition several aspects of transport through molecular sieve membranes, such as zeolite membranes, may also be revealed by performing the method with different condensable gass and making measurements at a variety of sample temperatures. For example, if a non-condensable gas is selected which has a molecular size that closely matches the micropore size, one can probe subtle changes in this micropore size. In this aspect the microporous membrane may have micropores in the membrane which are significantly different from each other. For a molecular sieve membrane such as an MFI zeolite this difference may be due to the presence of ions in the micropores which restrict access to the pore. This difference may be due to distortions in the crystal lattice due to the presence of additional framework metals such as aluminium. These micropore based differences may result in a change in the performance of the membrane such as for example reduced selectivity or permeance. The same membranes with and without these differences would appear identical in performance when tested with a non-condensable gas of a molecular size that is significantly smaller than the micropore size e.g. helium in the case of MFI zeolites. Thus in a further aspect the present invention provides for a method which uses a non-condensable gas in combination with an appropriate condensable gas which is selected to enable the nature of the microporosity of the membrane to be investigated and determined, and for the effects of micropore differences to be evaluated. In this aspect the condensable gas will condense in some but not all of the micropores of the membrane. An example of a suitable condensable gas in this aspect of the invention which may be used to evaluate MFI zeolite membranes is para-xylene, which may be used in combination with helium as the non-condensable gas. In the case of MFI zeolites the evaluation with paraxylene is compared with a corresponding evaluation using for example hexane. The paraxylene may enter some but not all of the micropores whereas the normal hexane will enter all of the micropores. A comparison of the helium permeance performance with each condensable material may show that an amount of helium permeance is maintained in the case of paraxylene exposure when compared to the normal hexane exposure; this is indicative of the presence of micropores in the membrane in which paraxylene is unable to condense; these micropores remain open to helium flow. Thus this method can detect and quantify such micropores. In a further aspect a condensable molecule may be selected which is clearly too large to pass into and therefore condense within the micropores of the membrane. In this method the condensable material will condense in all pores other than the micropores; it will condense in those pores which are responsible for non-selective flow leaving micropores for selective flow open. Thus the residual permeance of helium is due to floe through selective micropores only. An example of a suitable molecule in this aspect for use with MFI zeolites is 1,3,5 trimethylbenzene; in this case the molecule is acting as a marker for bypass flow in the zeolite membrane.

It should be understood that the three procedures described above in relation to zeolite membranes are applicable to any microporous membrane. The evaluations and comparisons may be carried out with any combination of condensable and non-condensable gases; the molecular dimensions of the gases may be selected to allow any number of comparative evaluations to be undertaken in order to probe and determine and characterize the nature of the membranes microporosity.

The methods of the present invention may be used to evaluate all types of membrane. However, it is of particular application to microporous inorganic membranes and most especially molecular sieve membranes such as zeolite membranes as made by any methods known in the art. Examples of molecular sieve membranes which may be evaluated by the methods of the present invention are described in Published International Applications WO 94/25151, WO 96/01683, WO 96/01686, WO 97/25129, WO 97/33684, WO 00/53297, and WO 00/53298, or those described by Xomeritikas and Tsapatsis in Chemical Materials, 1999, 11, 875-878.

The crystalline molecular sieve layer may be any known molecular sieve material; for example it may be a silicate, an aluminosilicate, an aluminophosphate (ALPO's), a silicoaluminophosphate, a metalloaluminophosphate, or a metalloaluminophosphosilicate.

Representative examples are molecular sieves/zeolites which may be used in the molecular sieve layer include the structure types AFI, AEL, BEA, CHA, EUO, FAU, FER, KFI, LTA, LTL, MAZ, MOR, MEL, MTW, OFF, TON and, especially and preferably MFI.

Some of the above materials while not being true zeolites are frequently referred to in the literature as such, and this term will be used broadly in this specification.

It will be appreciated that the structure comprising a crystalline molecular sieve layer and a support may be of any shape, and may be, for example, planar, cylindrical, especially cylindrical with a circular cross-section, or may be a honeycomb structure.

The method of the present invention may be used to characterize microporous membranes of any thickness. It is especially useful for the characterization of relatively thin membranes. The method may be used to characterize microporous membranes, e.g. crystalline molecular sieve layers, of 3 μm or less, more advantageously 2 μm or less, and especially membranes which are 1 μm or less most preferably 0.5 μm or less. Advantageously, when the microporous membrane is a zeolite membrane, the thickness of the layer, and the crystallite size of the crystalline molecular sieve, are such that the layer thickness is approximately the size of the longest edges of the crystals, giving essentially a monolayer. In such a monolayer the crystals are orientated such that the crystalline molecular sieve layer exhibits a columnar appearance when viewed in cross-section by SEM. In such a structure the majority of the inter-crystal grain boundaries are oriented substantially perpendicular to the plane which approximates to the interface between the support and crystalline molecular sieve layer. The crystalline molecular sieve layer contains substantially no crystals which are orientated such that the plane of their grain to grain interfaces are parallel to the support/crystalline molecular sieve layer interface.

The methods of the present invention are particularly suitable to characterize crystalline molecular sieve layers in which the crystals are contiguous, i.e. substantially every crystal is in contact with one of its neighbours, although not necessarily in contact with one of its neighbours throughout its entire length.

The method of the present invention may also be used on reparated microporous membranes, that is membranes which have been treated to reduce the effect of non-selective pathways. In this aspect the method of the present invention is being utilised to determine the effectiveness of the reparation technique or process to enable further treatments to be undertaken or to confirm that the reparated membrane has acceptable properties for the desired end application.

The methods of the present invention may be utilised on supported or non-supported membranes. Its is especially suitable for use with supported membranes especially supported zeolite membranes.

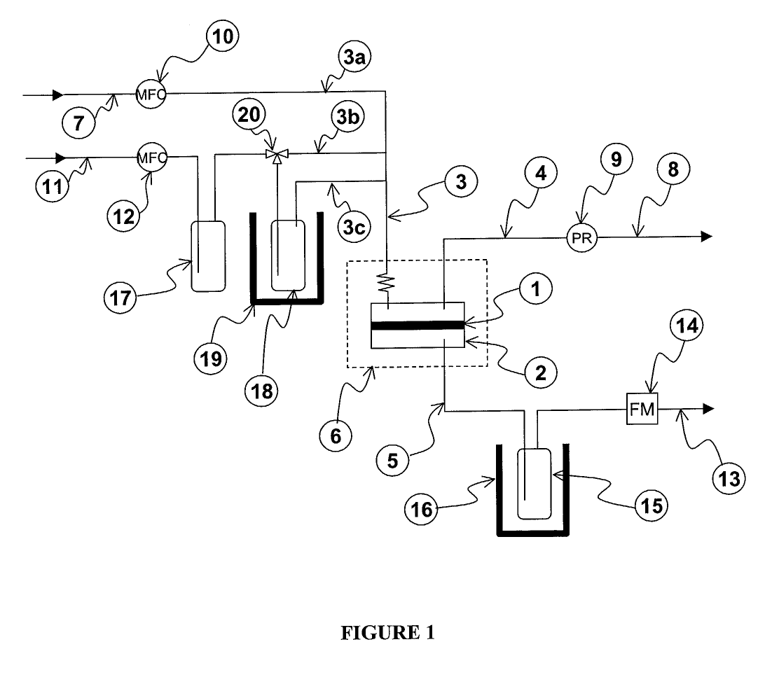

FIG. 1. This Figure is a schematic representation of an apparatus which may be used in the method of the present invention.

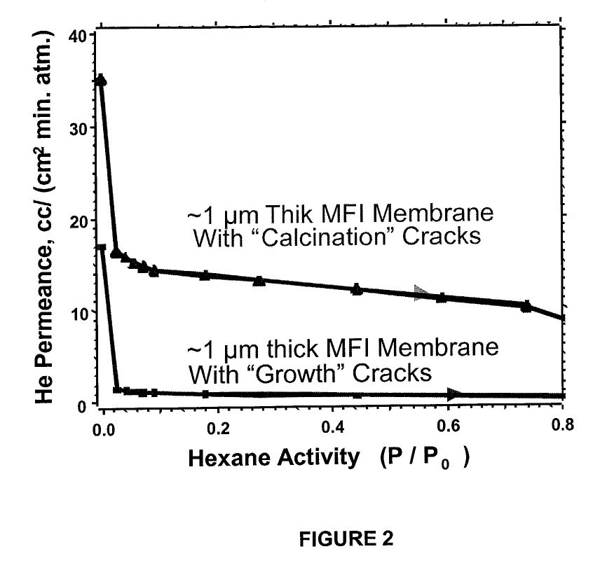

FIG. 2. This Figure shows the variation of permeance with hexane activity for two different low aluminum ZSM-5 membranes taken at ˜25° C. The membranes were grown on alpha alumina supports that have ˜1,000 Å sized pores at their surface.

The method of the present invention may be undertaken using the apparatus as depicted in FIG. 1. This is only one way of carrying out the method of the present invention; it will be appreciated by the skilled addressee that minor variations or alternative equivalents to specific items of the described apparatus may be used. Briefly in this apparatus the condensable material is introduced through a bubbler. By blending together a stream of the non-condensable gas flowing through the bubbler and a pure stream of the non-condensable gas, different levels of vapor partial pressure can be achieved. In this apparatus the bubbler is run under pressure and the stream containing the condensable gas flows under pressure on the feed side of the membrane during the measurement itself. Permeate flow is measured with a flow meter such as a bubble flow meter operating at atmospheric pressure. Before performing the method of the present invention, the membrane sample may be treated in-situ to remove molecular species. This treatment may be simple cleaning process or if the membrane is resistant to high temperature e.g. a zeolite membrane, it may be calcined within the holder or heated in-situ to remove molecular species which may be strongly sorbed in the zeolite. After conditioning the sample, an initial measurement is made with no flow through the bubbler, so the initial activity of the condensable gas is zero. Successive non-condensable gas permeation measurements are then made with increasing activities of the condensable gas carried in the non-condensable feed stream.

Depending on the nature of the materials used to manufacture the apparatus for carrying out the characterization method it may be necessary to condition the test equipment before undertaking testing. This is to ensure that no adsorbed species present in these materials is desorbed during the test and thus interfering with the evaluation. For example when graphite seals are used it is essential that they are conditioned to ensure that adsorbed species are removed.

The method of the present invention will now be exemplified and described in detail with reference to FIG. 1. In the following description a method according to the present invention is described in relation to the evaluation of a zeolite membrane utilising helium and hexane. The general procedure described is equally applicable to other microporous membranes and other condensable and non-condensable gases. For MFI zeolites hexane, helium and paraxylene may be used.

A microporous membrane (1) is sealed into a membrane holder (2) fitted with a feed line (3) which includes a pre-heating coil, a retentate line (4) and a permeate line (5). The membrane is sealed into the holder using graphite seals that have been pre-baked at 350° C. to remove any volatile material. The membrane holder is placed inside an oven or sandbath (6). The membrane is heated under He flow to remove any adsorbed gases. For MFI zeolite membranes a typical procedure is to heat up at 2° C./min to 250° C., keep at 250° C for 3 hours, cool down to the desired testing temperature Tₜₑₛₜ. A typical testing temperature is room temperature.

To measure the flow of pure carrier gas, i.e. P/Pₒ=0 (where P=partial pressure of condensable gas; Pₒ=saturation partial pressure of condensable gas), the following setting is used. The carrier gas feed line (7) is opened. The carrier gas, typically He, flows through feed line (3a) to the membrane holder (2). The retentate flows through line (4) to the vent (8). The feed pressure P_{feed} is set by the pressure regulator (9), the flow is set by the mass flow controller (10). (The gas feed line (11) and mass flow controller (12) remain closed). The gas permeated through the membrane flows through permeate line (5) to the vent (13). The permeate flow is measured by the flow meter (14). The permeate is at atmospheric pressure. An optional cold trap (15) in a cold bath (16) can be used to condense any gases that may damage the flow meter. To measure partial pressures of the condensable gas between P/Pₒ=0 and P/Pₒ=1, the following setting is used. The saturators (17) and (18) are filled with the selected liquid, e.g. n-hexane. Saturator (17) is at T₁ (typically room temperature), saturator (18) is kept at a controlled temperature T₂ below T₁ by the cooling bath (19). The two carrier gas lines (7) and (11) are opened, the gas flows are controlled by mass flow controllers (10) and (12). The three-way valve (20) is set such that the gas flows from saturator (17) through saturator (18) to feed line (3c). The gas stream (3c) carries the condensable gas at a concentration equal to the saturation concentration at a temperature T₂. The three-way valve (21) is set to the vent (22) for a time sufficient to equilibrate the saturators (typically 30 minutes). When the saturators have reached equilibrium, the three-way valve (21) is set such that the stream carrying the condensable gas (3c) is combined with the pure non-condensable carrier gas stream (3a) and flows to the membrane holder through feed line (3). The retentate flows through the line (4) to vent (8). P_{feed} is set by the pressure regulator (9). Part of the condensable gas will condense in the membrane, closing or reducing the effective diameter of part of the pores. The permeate through the remaining pores flows through the permeate line (5) and if desired through cold trap (15), where the condensable gas is separated, to vent line (13). The permeate flow is measured by flow meter (14). The permeate is at atmospheric pressure. The partial pressure of the condensable gas at the membrane is controlled by T₂, Tₜₑₛₜ and the ratio of the flows through (3a) and (3c). The test is run for a series of different ratios of the flows, see Table 1 for an example. The highest partial pressure of the condensable gas, close to P/Pₒ=1, is measured by closing feed line (7) and setting three-way valve (20) such that saturator (18) is bypassed, and the stream from saturator (17) passes directly to feed lines (3b) and (3). Now the partial pressure of the condensable gas at the membrane is controlled by T₁ and Tₜₑₛₜ.

TABLE 1

| | | | | P_{feed} | MFC | MFC | Valve |
|---|---|---|---|---|---|---|---|
| | T₁ | T₂ | Tₜₑₛₜ | kPa | (10) | (12) | (20) |
| P/P₀ | ° C. | ° C. | ° C. | (g) | ml/min | ml/min | set to |
| 0 | 24 | 15 | 24 | 100 | 450 | 0 | — |
| 0.02 | 24 | 15 | 24 | 100 | 450 | 14 | (3c) |
| 0.2 | 24 | 15 | 24 | 100 | 120 | 50 | (3c) |
| 0.7 | 24 | 15 | 24 | 100 | 0 | 50 | (3c) |
| 1 | 24 | — | 24 | 100 | 0 | 50 | (3b) |

In Table 1 MFC=Mass Flow Controller, the carrier gas=He, the condensable gas=n-hexane, the membrane area=2.84 cm², and the cold trap (15) was set to 15° C.

### EXAMPLE 1

Two MFI zeolite membranes of approximately 1 μm thickness were prepared using a hydrothermal synthesis method on alpha alumina supports that were initially seeded with colloidal MFI crystals. These membranes were calcined. The general procedure for their preparation is provided in WO 00/53297 or WO 00/53298. These membranes were evaluated and characterized using the method described above in relation to FIG. 1. The results of this evaluation are provided in FIG. 2.

Inspecting FIG. 2 it can be seen that the He permeance drops precipitously for both membranes as the hexane activity is increased from 0 to ˜0.02 where He transport through zeolite crystals is blocked. The magnitude of this permeance drop is a measure of the selective permeance, which is approximately the same for both the membranes shown in FIG. 2. The flow remaining at an activity of 0.8 is due to flow through defects with sizes of greater than ˜17 nm. It can be seen that one of the membrane structures has an appreciable flow remaining at an activity of 0.8. This membrane contains a significant crack structure which is referred to as calcination cracks. This type of crack structure crosses through individual zeolite crystals and can often extend all the way to the base of the membrane structure, leaving open a direct pathway to the support. The other membrane shown in FIG. 2 has an almost negligible flow remaining at a hexane activity of 0.8, indicating an absence of non-selective permeation pathways with sizes greater than ˜17 nm. High resolution electron micrographs of this membrane reveal correlated structures that link the grain boundaries between zeolite crystals. These types of structures are referred to as growth cracks. It is seen that membranes with growth cracks can have a relatively small amount of non-selective permeation through their structure. Thus with the method of the present invention it is possible to detect molecular sieve membranes which have significant levels of non-selective calcination cracks and those which have growth cracks.

The amount of non-selective permeance that is expected in other transport experiments (for example binary separations) can be quantitatively predicted from the permeance measured in these experiments. Flows in the activity range from 0.02 to 0.8 can be used to predict a pore size distribution of bypass pores that have sizes greater than that of the zeolite. General transport rules can then be used to scale the flows through these pore structures to predict the bypass flow in the specific transport experiment being conducted. In many cases it is possible to simply use the He permeance at a hexane activity of 0.02 to provide an accurate estimate of the bypass permeance in other experiments. When there are small enough pores in the underlying support or there is a relatively small permeance left at an activity of 0.8, bypass permeance in gas transport experiments can be scaled from the He permeance at an activity of 0.02 with a simple Knudsen scaling law. The use of this type of scaling law in conjunction with the method of the present invention is able to predict initial bypass permeance in xylene isomer separation experiments. In these experiments we have been able to confirm the amount of bypass or non-selective permeance with a marker (1,3,5 trimethylbenzene) which will not pass through the micropores of MFI zeolites.

What is claimed is:

1. A method for determining the permeation properties of a microporous membrane, which method comprises,
a) exposing the membrane under permeation conditions to an non-condensable material and measuring the permeance of the material,
b) introducing a condensable material to the non-condensable gas during the exposure,
c) increasing the partial pressure of the condensable material during the exposure, and
d) measuring the change in permeance of the non-condensable material at the increased partial pressures of condensable material.

2. The method recited in claim 1, wherein the non-condensable material is an inert non-condensable material.

3. The method as claimed in claim 2, wherein the membrane is an inorganic membrane.

4. A method as claimed in claim 3, wherein the membrane is a molecular sieve membrane.

5. The method as claimed in claim 4, wherein the membrane is selective.

6. The method as claimed in claim 4, wherein the membrane is a membrane for separating CO₂/methane mixtures.

7. The method as claimed in claim 4, wherein the membrane is a membrane for separating paraxylene from a mixture comprising xylene isomers.

8. The method as claimed in claim 4, wherein the membrane is an MFI zeolite.

9. The method as claimed in claim 1, wherein graphite seals are used which have been pre-baked.

10. The method as claimed in claim 1, in which the condensable material has a molecular size which is closely matched to the pore size of the microporous membrane.

11. The method as claimed in claim 1, wherein the condensable material has a molecular size which is greater than the pore size of the microporous membrane.

12. The method as claimed in claim 1, wherein the microporous membrane has been reparated.

13. The use of a method as described in claim 1, for the quality control of microporous membranes during and/or after their manufacture.

14. The use as claimed in claim 13, wherein the quality control method determines the need for microporous membrane reparation.

15. The use as claimed in claim 13, wherein the quality control method detects and/or quantifies non-selective permeation pathways in the membrane.

16. The use as claimed in claim 13, wherein the quality control method detects micropore related perturbations in the microporous membranes.

17. The use as claimed in claim 13, in which the quality control method selects microporous membranes which have a predefined selective permeance or deselects microporous membranes which have a predefined unacceptable bypass flow.

18. The use of the method as claimed in claim 1 for monitoring the condition of microporous membranes in-situ.
